(19) United States
(12) Patent Application Publication
(10) Pub. No.: US 2006/0097509 A1
(43) Pub. Date: May 11, 2006

(54) Report cover

(76) Inventors: James A. Fasan, Newmarket (CA); Robert G. Dickie, Newmarket (CA)

Correspondence Address: SAND & SEBOLT, AEGIS TOWER, SUITE 1100, 4940 MUNSON STREET, NW, CANTON, OH, 44718-3615, US

(21) Appl. No.: 10/985,277

(22) Filed: Nov. 10, 2004

(51) Int. Cl. B42D 3/00

(52) U.S. Cl. 281/29

(57) ABSTRACT

A report cover which can both secure loose papers therein and may itself be secured into a ring binder. The interior portion of the spine which lies between the front and back pages of the cover includes a securing device for loose papers. The securing device can be cooperating pronged fasteners and apertures, clamps or clasps. The exterior portion of the spine includes a plurality of apertures which are spaced apart from each other. The distance between the apertures is adapted to be complementary to the spacing between the prongs of a ring binder and more specifically to the prongs of a three-ring binder. The apertures in the spine may be formed within the exterior portion of the spine or may be offset therefrom. The offset apertures are formed by spring clips which are movably attached to the exterior portion of the spine. The apertures in the exterior portion of the spine receive the prongs of the ring binder therethrough. A plurality of report covers may therefore be secured within the same ring binder, with each of the report covers securing loose papers within them.

### BACKGROUND OF THE INVENTION

1. Technical Field

This invention generally relates to report covers. More particularly, the invention relates to flexible report cover into which loose pieces of paper may be filed. Specifically, the invention relates to a report cover which has a spine that both allow papers to be secured within the cover and allows the cover to be secured into a ring binder.

2. Background Information

It is common for school students to use inexpensive paperboard report covers to store and protect their worksheets and writing paper. These report covers typically comprise a folder which has an internal central spine which includes two-prong fasteners for securing papers therein. The student secures their three-hole punched papers into the report cover by inserting the prongs of the fasteners through the holes in the paper and then through apertures in the spine of the cover. The prongs are separated from each other and pushed into abutting contact with the spine of the cover. The report covers may also include pockets on the insides of the cover for holding loose sheets of paper. Alternatively, the student may use report covers which include Duo-Tang® fasteners, three prong metal fasteners or clamp type fasteners. Students may alternatively store their worksheets inside report covers which only have two pockets in the interior. Some of these two pocket report covers may have three holes punched in the cover to allow the report cover to be secured within a three-ring binder. These report covers, however, do not provide any mechanism for securing loose papers into the covers.

The student typically needs several report covers, using one report cover for each school subject. These report covers are carried around in the student's school bag and, because the covers are typically manufactured from an inexpensive, lightweight material, they tend to get easily damaged and crumpled. The covers therefore fail to serve their purpose as a protective storage device. Furthermore, the student may confuse one report cover with another and consequently bring incorrect papers to a particular class or may lose the entire report cover and its contents.

In order to address this problem, students may alternatively use hardcovered ring binders as a protective storage device for their papers and worksheets. However, in order to separate papers for different subjects, a series of dividers has to be used. This allows the student to store all of their materials, but if they need to remove all of the papers for one subject from the binder, the papers are then simply loose sheets that may become disorganized, lost or damaged.

Alternatively, students may use bound notebooks to ensure that their notes are both secure and protected. These notebooks do not, however, address the need for students to insert loose worksheets, maps or other papers into their notes relating to a particular subject.

There is therefore a need in the art for an inexpensive report cover which allows students to maintain all of their papers relating to one subject therein, but which can also be centrally organized and protected.

### SUMMARY OF THE INVENTION

The present invention is a report cover which has a spine which enables loose papers to be secured into the cover and which also allows the cover to be secured into a ring binder. A plurality of report covers may therefore be secured within a ring binder with each of the report covers being adapted to secure loose papers relating to a different subject. The exterior portion of the spine includes a plurality of apertures which are spaced apart from each other. The distance between the apertures is complementary to the spacing between the prongs of a ring binder and more specifically to a three-ring binder. The apertures in the spine may be formed within the exterior portion of the spine or may be offset therefrom. The offset apertures are formed by spring clips which are movably attached to the exterior portion of the spine.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a front view of a prior art report cover showing the cover in a closed position;

FIG. 2 is a front view of the report cover of FIG. 1 showing the cover in an open position;

FIG. 3 is a partial bottom view of the report cover of FIG. 2 showing the interior central spine and prong fasteners for attachment of papers therein;

FIG. 4 is front view of a first embodiment of the report cover in accordance with the present invention; and showing the report cover in a close position;

FIG. 5 is a perspective view of the report cover of FIG. 4 showing the cover in an open position;

FIG. 6 is a partial bottom view of the report cover of FIG. 4, showing both the interior and exterior central spine;

FIG. 7 is a partial front view of a second embodiment of the report cover in accordance with the present invention and showing the cover in an open position;

FIG. 8 is a partial bottom view of the report cover of FIG. 7, showing the detail of the exterior portion of the central spine;

FIG. 9 is a perspective view of a third embodiment of the report cover in accordance with the present invention and showing a variation in the construction of the exterior portion of the spine;

FIG. 10 is an enlarged partial perspective view of the spine of the report cover shown in FIG. 9;

FIG. 11 is a front view of a third embodiment of the report cover in accordance with the present invention and showing a spring clip in an extended position for engagement in a ring binder;

FIG. 12 is a side view of the spring clip that is inserted into the report cover of FIG. 11;

FIG. 13a is a perspective view of the exterior of the report cover showing the spring clips engaged in slots in the spine;

FIG. 13b is a perspective view of the interior of the report cover showing the spring clips engaged in slots in the spine;

FIG. 14 is a partial bottom view of the opened report cover;

FIG. 15 is a front view of the report cover with the spring clip in a retracted position;

FIG. 16 is a perspective view of a report cover in a position to secure a plurality of sheets of paper therein;

FIG. 17 is a perspective view of a report cover with the plurality of sheets of a paper secured therein;

FIG. 18 is a perspective view of the report cover of FIG. 17 in a closed position;

FIG. 19 is a perspective view of a plurality of report covers in accordance with the first embodiment of the invention being inserted into a ring binder for safekeeping; and

FIG. 20 is a perspective view of a plurality of report covers in accordance with the third embodiment of the invention being inserted into a ring binder for safekeeping.

### DETAILED DESCRIPTION OF THE INVENTION

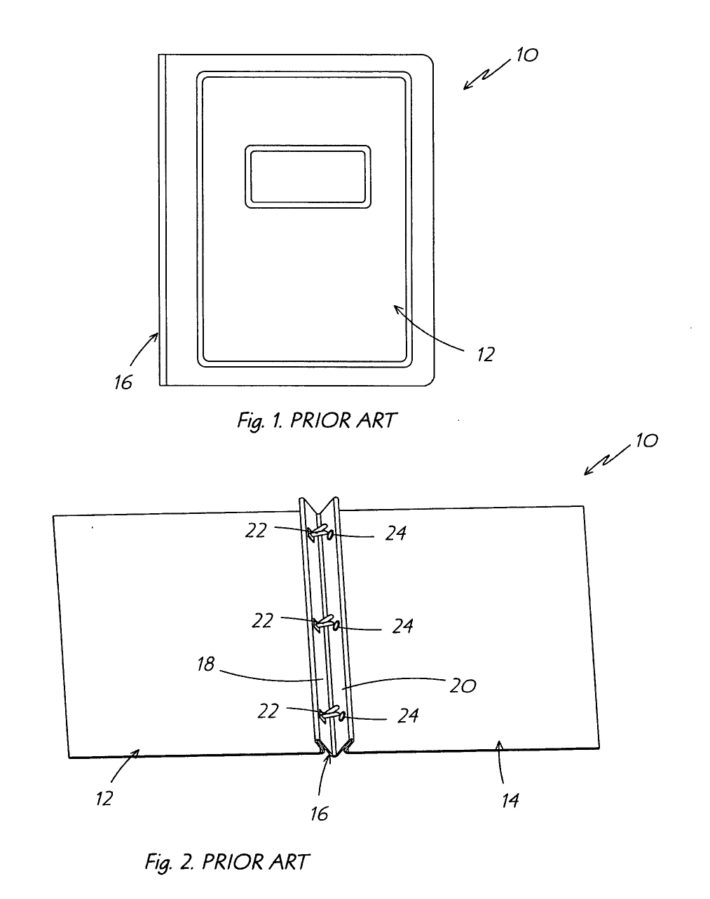

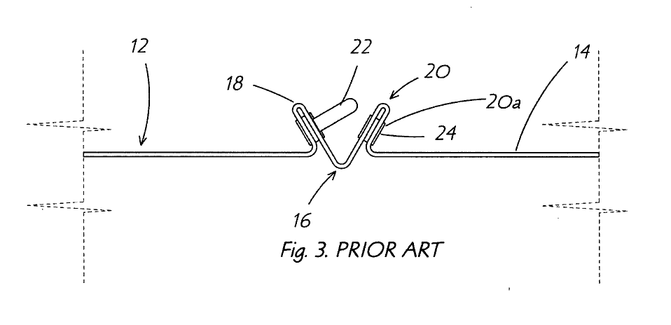

Referring to FIGS. 1-3 there is shown the previously known type of report cover, generally indicated at 10. Cover 10 includes a front sheet 12 and a back sheet 14 joined together at a spine 16. Spine 16 includes a first section 18 and a second section 20 which extend into the interior of cover 10. First section 18 has a plurality of two-pronged fasteners 22 and second section 20 has a plurality of corresponding apertures 24. A sheet of three-hole punched paper (not shown) can be secured into report cover 10 by inserting the prongs of fasteners 22 through holes in the paper and then into apertures 24. The prongs 22 are then opened up to lie flat against the side 20a of second section 20.

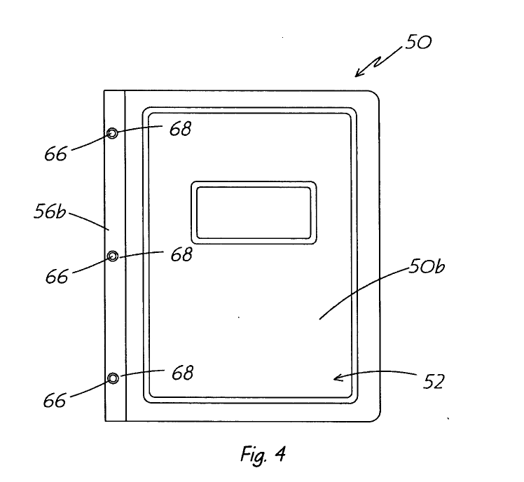

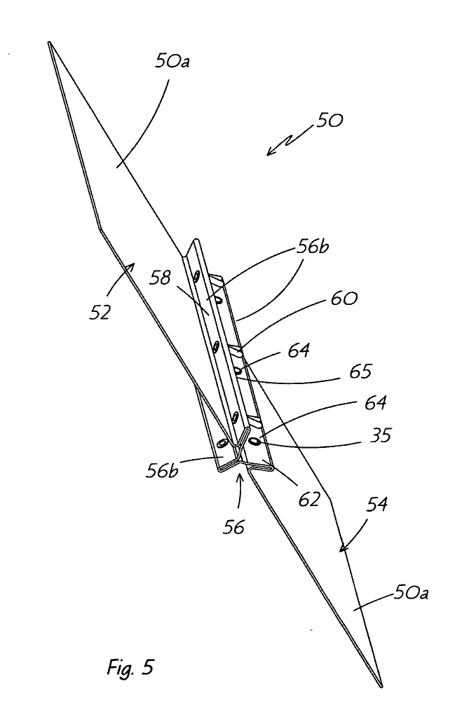

Referring to FIGS. 4-6, there is shown a first embodiment of a report cover in accordance with the present invention, and generally indicated at 50. Report cover 50 comprises a front sheet 52 and a back sheet 54 joined together at a spine 56. Cover 50 has an inner surface 50a and an outer surface 50b. Spine 56 includes an interior portion 56a which extends outwardly from the inner surface 50a of cover 50. Interior portion 56a of spine 56 has a first section 58 with a plurality of two-pronged fasteners 60 extending therefrom and a second section 62 with a plurality of corresponding apertures 64 formed therein. Apertures 64 preferably also include a reinforcing ring 65 disposed thereabout. A sheet of three-hole punched paper (not shown) may be secured into report cover 50 by inserting the prongs of fasteners 60 through holes in the paper and then through apertures 64. Apertures 64 may be reinforced as is common in the art. The prongs are then opened up to lie flat against the side 62a of second section 62.

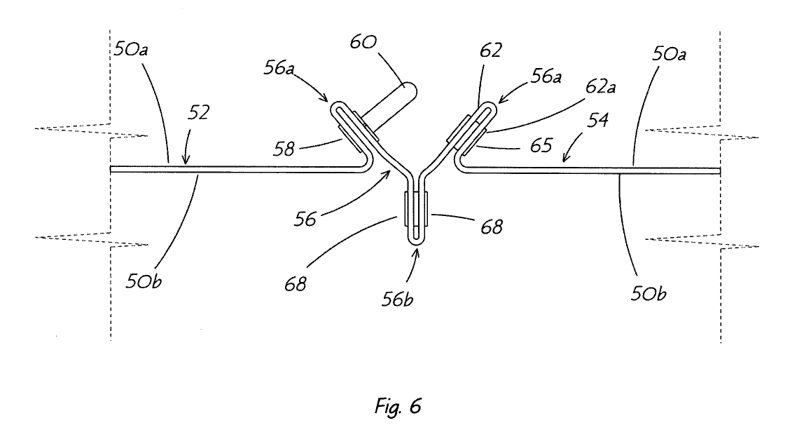

In accordance with one of the specific features of the present invention, spine 56 also includes an exterior portion 56b which extends outwardly from the outer surface 50b of cover 50 (FIGS. 1 & 6). Exterior portion 56b of spine 56 includes a plurality of apertures 66 therein. Apertures 66 are spaced and configured to engage the prongs of a three-ring binder as will be described hereinafter. As may be most clearly seen in FIG. 6, apertures are circumscribed by a reinforcement 68. Exterior portion 56b of spine 56 preferably is formed from at least one fold of paper which consequently forms a spine 56 having two layers of material with aligned apertures 66 therein. Reinforcement 68 is applied around apertures 66 in such a manner that both layers of material are connected together and do not separate from each other when cover 50 is opened. A suitable reinforcement 68 would be a metal grommet or a paper or fiber ring surrounding apertures 66.

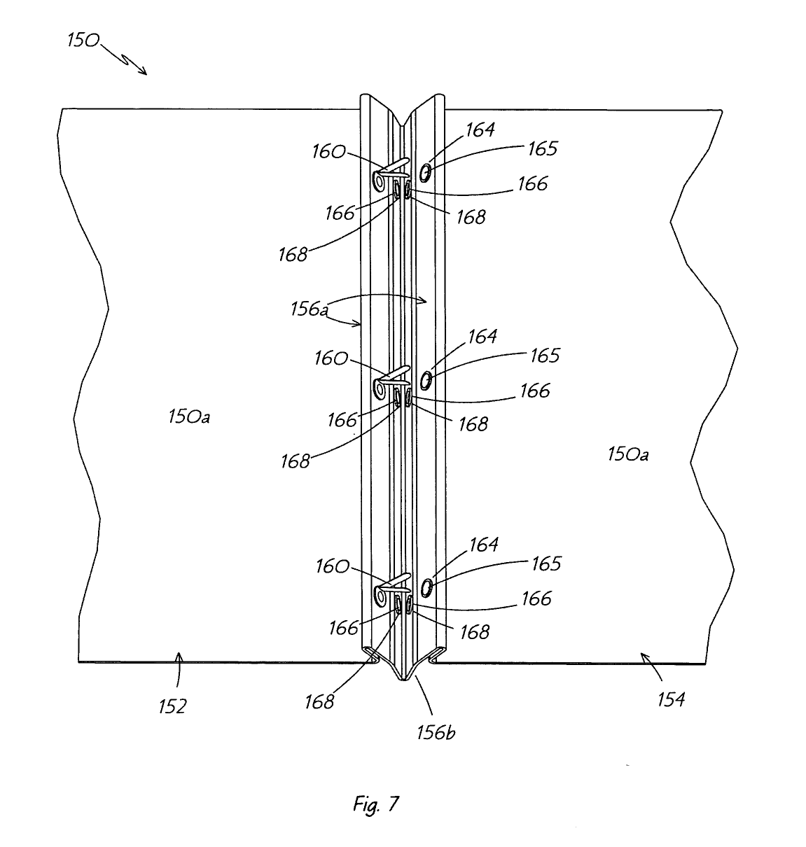

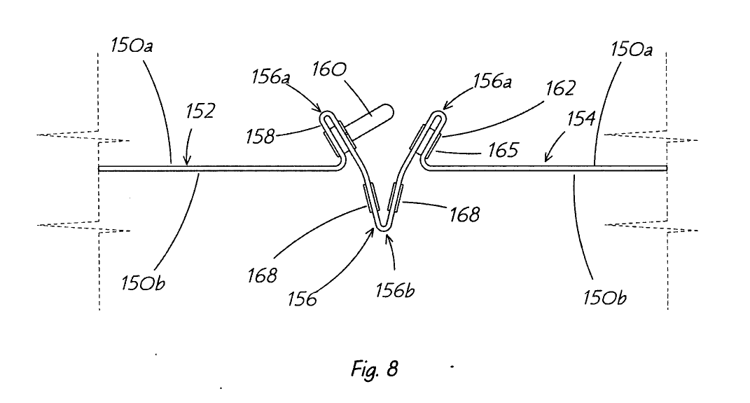

A second embodiment of report cover is shown in FIGS. 7 & 8 and is generally indicated at 150. As with the first embodiment, cover 150 has a front sheet 152 and a back sheet 154 joined together at a spine 156. Cover 150 has an inner surface 150a and an outer surface 150b. An interior portion 156a of spine 156 extends outwardly from inner surface 150a of cover. An exterior portion 156b of spine 156 extends outwardly from outer surface 150b of cover. Exterior portion 156b of spine 156 preferably is formed from at least one fold of paper, but in this embodiment of the invention, each layer of the fold remains separated from the other. Each layer has a plurality of apertures 66 therein and each aperture 66 is circumscribed by a reinforcement 168. Interior portion 156a of spine is substantially identical to the interior portion 56a of the first embodiment and includes a first section 158 with prongs of fasteners 160 extending therefrom. Interior portion 156a further includes a second section 162 with a plurality of correspondingly positioned apertures 164 therein. As with the previous embodiment, apertures 164 may also be reinforced with a ring 165 as is common in the art. The configuration of the exterior portion 156b of spine 156 allows spine 156 to be opened wider allowing for easier insertion of pieces of paper (not shown) into cover through the increased clearance between the prongs of fasteners 160 and the apertures 164 which receive them.

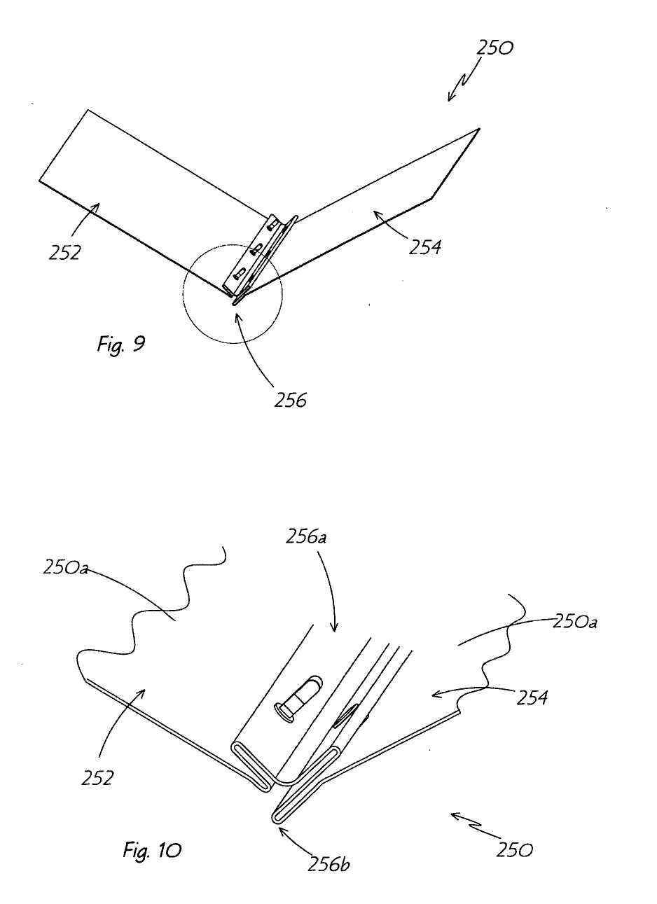

A third embodiment of the report cover in accordance with the present invention is shown in FIGS. 9 and 10, and is generally indicated at 250. As with the previous embodiments, cover 250 has a front sheet 252, a back sheet 254, an inner surface 250a and an exterior surface (not shown). Front and back sheets 252, 254 are joined together at a spine 256. Spine 256 includes an interior portion 256a and an exterior portion 256b. Exterior portion 256b of spine 256 is formed as a fold in only the back sheet 254 of cover 250. It will, of course, be understood that the fold may alternatively be formed in only the front sheet 252 of cover 250. As with the previous embodiments, exterior portion 256b of spine 256 is provided with a plurality of reinforced apertures (not shown) which are adapted to engage the prongs of a ring binder.

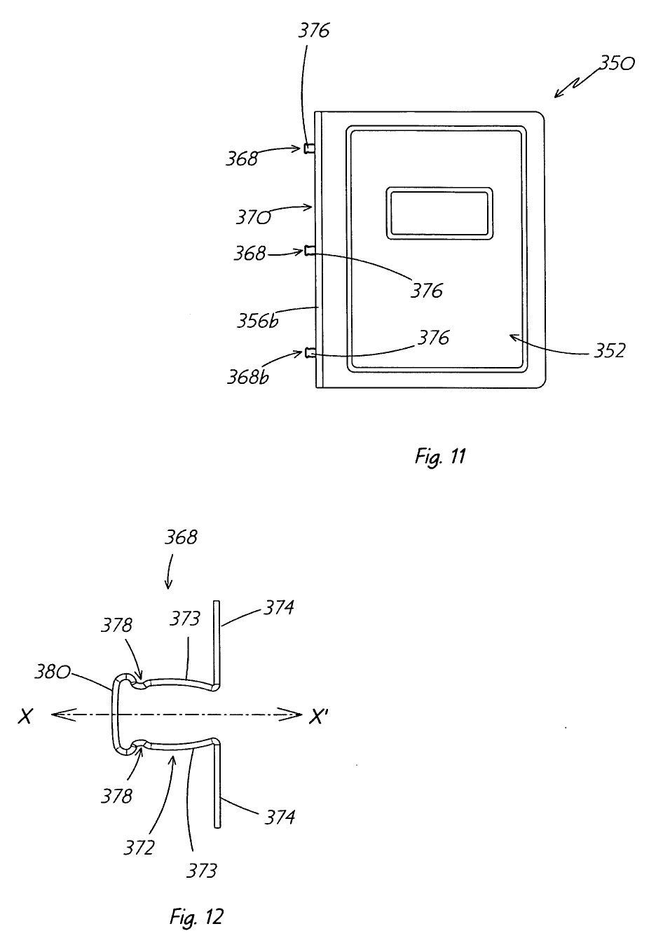

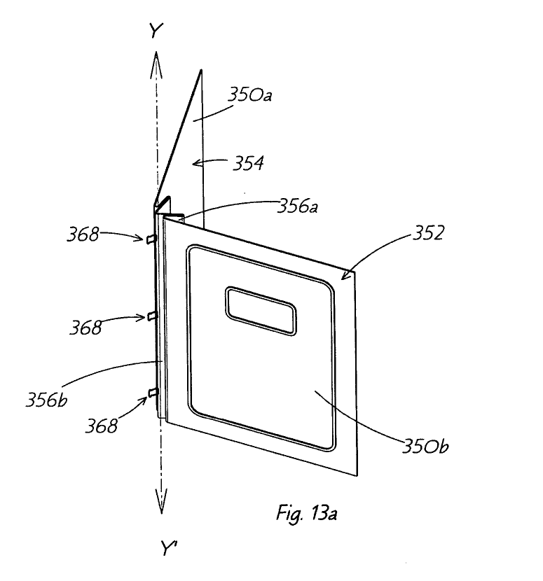

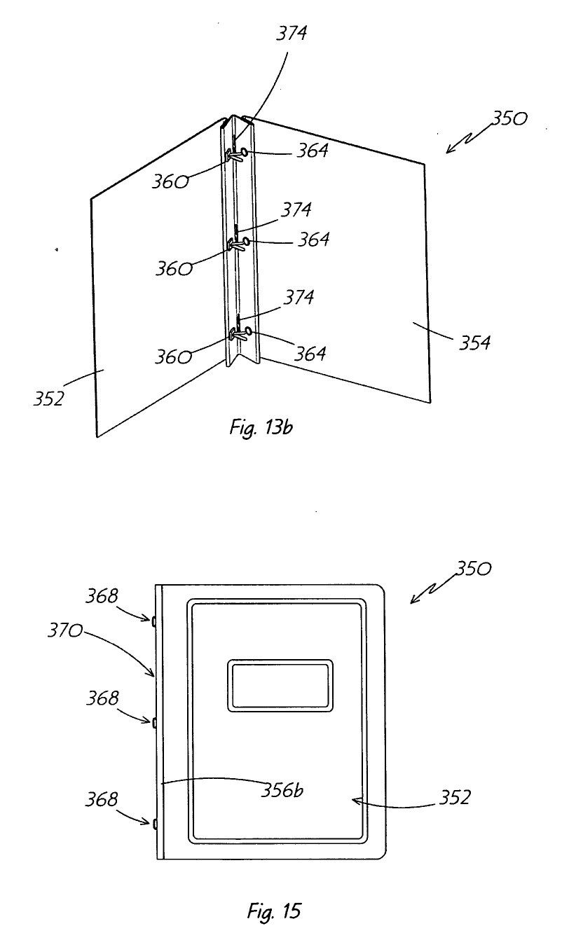

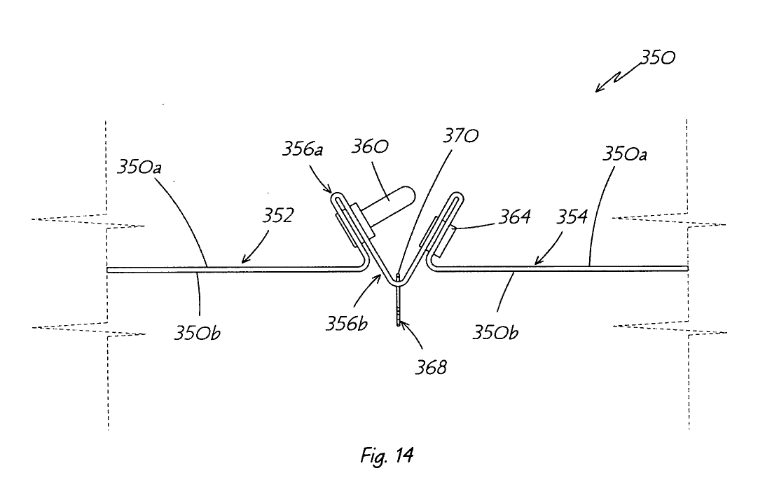

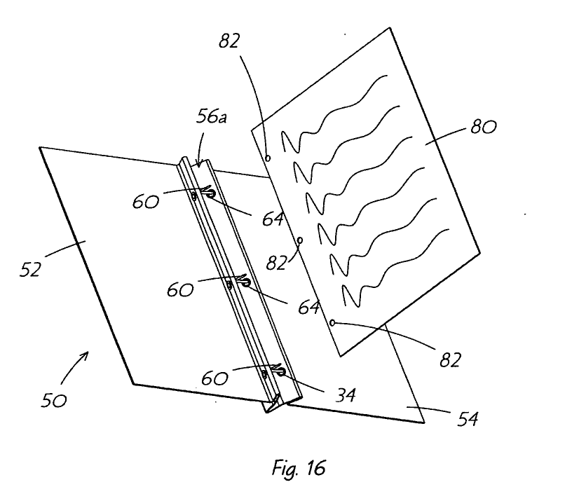

A fourth embodiment of the report cover in accordance with the present invention is shown in FIGS. 11-15, and generally indicated at 350. As with the previous embodiments, cover 350 has a front sheet 352, a back sheet 354, an inner surface 350a and an exterior surface 350b. Front and back sheets 352, 354 are joined together at a spine 356. Spine 356 includes an interior portion 356a and an exterior portion 356b. Exterior portion 356b is formed from at least one fold of material and the two layers of material in the fold are not connected together. A plurality of slots (not shown) is formed at intervals along the apex 370 of exterior portion 356b. The slots lie substantially parallel to the longitudinal axis Y-Y′ of the exterior portion 356b of spine 356 (FIGS. 11a & 11b). The position of the slots corresponds to the spacing between the prongs (not shown) of a three-ring binder. A reinforcing spring clip 368 is received within each slot. Clip 368 preferably is manufactured from either metal or plastic. Clip 368 includes a generally U-shaped tab portion 372 from which a pair of legs 374 extend. Tab portion 372 of each clip 368 further includes a hole 376 which is adapted to engage the prong of the three-ring binder. Tab portion has a longitudinal axis shown at X-X′ in FIG. 10. Legs 374 extend from tab portion 372 substantially at right angles to the longitudinal axis X-X′ of tab portion 372. Legs 374 are inserted through the slot in spine 356 and when inserted, legs 374 lie in proximity to inner surface 350a of cover 350. Tab portion 372 of reinforcing clip 368 has side walls 373 which include a pair of coplanar indentations 378 therein. When indentations 378 on side walls 373 of clip 368 engage in one of the slots in spine 356, then an end wall 380 (FIG. 10) of clip 368 lies substantially in abutting contact with exterior portion 356b of spine 356. When clip 368 is pulled outwardly in the direction of arrow “A” (FIG. 16), then end wall 380 lies remote from apex 370 of spine 356 and a hole 376 is formed between end wall 380 and apex 370. When in this position, the prong of a ring binder can be received through hole 376. End wall 380 of clip 368 is pushed inwardly into abutting contact with apex 370 of spine 356 when cover 350 is being used and is not being stored in the ring binder. The user inserts loose sheets of paper into cover 350 by passing the prongs 360 of the fasteners in interior portion 356a of spine 356 through holes punched in the paper and then into cooperating apertures 364 in interior portion 356a of spine 356.

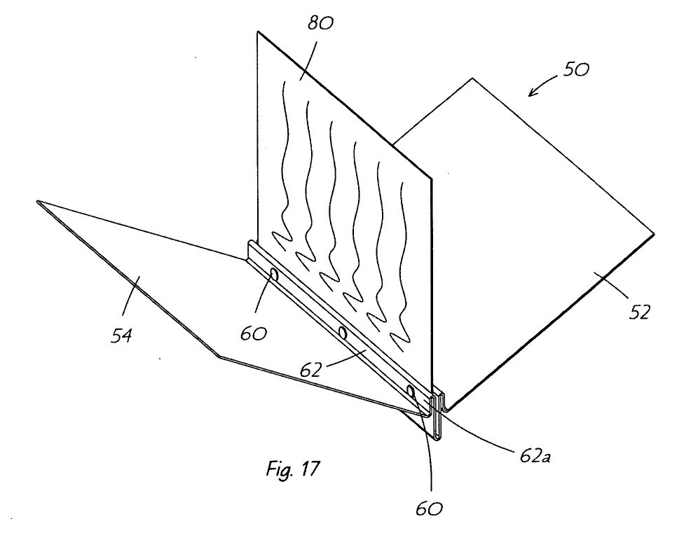

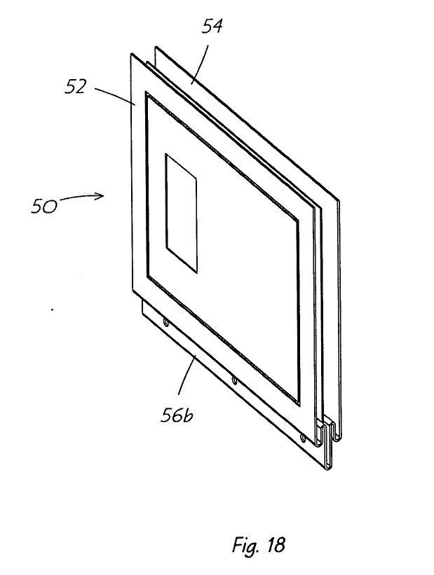

Referring to FIGS. 16-18, the report cover of the present invention is used in the following manner. A plurality of sheets of paper 80 may be secured into cover 50 in the following manner. Each sheet of paper 80 preferably is provided with three holes 82. The user pushes the prongs of fastener 60 through holes 82 in the paper and then through apertures 64 in interior portion 56a of spine 56. The prongs of fasteners 60 are then separated from each other and pushed into abutting contact with the surface 62a (FIG. 17) of second section 62 of spine 56. At this point pages 80 are secured within report cover 50.

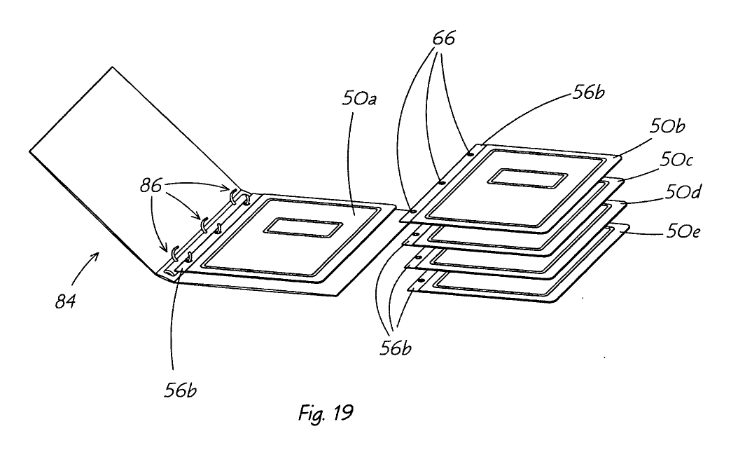

With reference to FIG. 19, a plurality of report covers 50A, 50B, 50C, 50D and 50E may be secured into a three ring binder 84. It will be understood that report covers in accordance with the second and third embodiments of the invention may similarly be secured into a binder 84. Each cover 50A-E includes an interior portion (not shown) of a spine which allows a plurality of sheets of paper to be secured therein as described above. Each cover 50A-E also includes an exterior portion 56b of a spine which has a plurality of apertures 66 formed therein. The covers 50A-E are secured into three-ring binder 84 by inserting the binders prongs 86 through apertures 66 in the covers. The prongs 86 are then snapped shut in the customary manner. This allows several covers 50A-E to be transported within binder 84 and to be individually removable when needed.

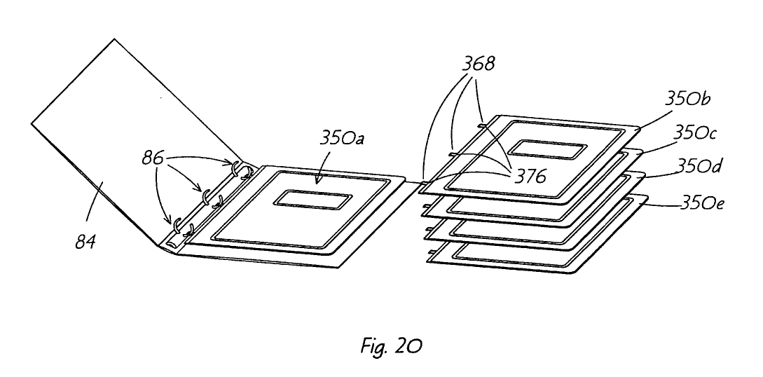

Similarly, as is shown in FIG. 20, a plurality of report cover 350A through 350E may be inserted into three-ring binder 84. In this instance, spring clips 368 are pulled from the second position (as shown by clip 368a in FIG. 15) to the first position (shown by clips 368b in FIG. 11) so that hole a 376 is formed between apex 370 and end wall 380 (FIGS. 11 & 12). Prongs 86 of three-ring binder 84 are inserted through holes 376 in clips 368. Prongs 86 are then snapped shut to secure the plurality of report covers 350A through 350E into binder 84.

It will be understood that while the above description has been directed to report covers that have two-prong fasteners 60 in the interior portion 56a of spine 56, the report covers may have an alternative means for securing loose papers 80 into the cover. So, for example, the securing mechanism may be three-prong fasteners or a clamp-type fastener. Furthermore, while the report covers are shown to have three apertures 66 formed in the exterior portion 56b of the spine 56, it will be understood that the cover may include only two apertures or more than three apertures therein. Additionally, the exterior and interior portions of the spine are shown to be made from a fold in the material. The interior and exterior portions may alternatively be made from one or two layers of material connected into the report cover in any suitable manner. Furthermore, it will be understood that the distance to which the exterior portion of the spine extends outwardly from the outer surface of the cover may vary. That distance does, however, have to be sufficient for apertures to be formed in the exterior portion of the spine in positions which allow the apertures to engage the prongs of a ring binder.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A report cover for storing loose papers therein; wherein the cover includes:
a mechanism for securing the loose papers into the cover;
a mechanism for securing the cover into a ring binder.

2. The report cover as defined in claim 1, wherein the mechanism for securing the cover into a ring binder comprises a plurality of apertures formed in a spine of the cover, the apertures being spaced apart a distance adapted to be complementary to the distance between the prongs of the ring binder.

3. The report cover as defined in claim 2, wherein each of the apertures in the spine of the cover is reinforced with a reinforcement.

4. The report cover as defined in claim 3, wherein the reinforcement is a metal grommet.

5. A report cover for securing a plurality of sheets of paper therein; said cover comprising:
a front page having an inner surface and an outer surface;
a back page having an inner surface and an outer surface;
a spine connecting the front page to the back page; and wherein the spine comprises:
an interior portion extending between the inner surfaces of the front and back pages;
an exterior portion extending outwardly from the outer surfaces of the front and back pages;
a securing mechanism for securing the sheets of paper to the interior portion of the spine;
a plurality of apertures in the exterior portion of the spine; the apertures being spaced apart and adapted to engage the prongs of a ring binder.

6. The report cover as defined in claim 5, further comprising a reinforcement associated with each of the apertures in the exterior portion of the spine.

7. The report cover as defined in claim 6, wherein the reinforcement circumscribes the aperture.

8. The report cover as defined in claim 7, wherein the reinforcement is selected from the group consisting of a metal grommet, paper ring and fiber ring.

9. The report cover as defined in claim 5, wherein the exterior portion of the spine is comprised of two layers of material.

10. The report cover as defined in claim 9, wherein the exterior portion of the spine is formed from at least one fold of material and the two layers of material are part of the fold of material.

11. The report cover as defined in claim 10, wherein the at least one fold of material is formed as part of one of the front page and back page of the cover.

12. The report cover as defined in claim 9, wherein the apertures in the exterior portion of the spine are formed in both layers of material and are disposed in co-aligned pairs.

13. The report cover as defined in claim 12, further comprising a plurality of reinforcements, and wherein each reinforcement circumscribes one of the co-aligned pairs of apertures, whereby the two layers of material of the exterior portion of the spine are secured together by the reinforcements associated with the pairs of apertures.

14. The report cover as defined in claim 13, wherein the reinforcements are metal grommets.

15. The report cover as defined in claim 5, wherein the interior portion of the spine comprises a first section having a plurality of prong-type fasteners disposed therein and a second section having a plurality of apertures formed therein; wherein each prong-type fastener is aligned with an aperture and is receivable therethrough.

16. The report cover as defined in claim 15, further comprising a reinforcement disposed about each aperture formed in the second section of the interior portion of the spine.

17. The report cover as defined in claim 9, wherein the fold of the exterior portion of the spine includes an apex and the apertures are formed at spaced intervals along the apex of the fold.

18. The report cover as defined in claim 17, wherein the apertures comprise slots lying substantially parallel to a longitudinal axis of the exterior portion of the spine.

19. The report cover as defined in claim 18, further comprising a plurality of spring clips; wherein said spring clips are each engageable in one of the slots in the exterior portion of the spine.

20. The report cover as defined in claim 19, wherein each spring clip includes a tab portion and a pair of legs extending from the tab portion; and wherein the legs are receivable within one of the slots in the exterior portion of the spine.

21. The report cover as defined in claim 20, wherein the tab portion is substantially U-shaped.

22. The report cover as defined in claim 21, wherein the U-shaped tab portion has a longitudinal axis and the legs of the clip extend outwardly from the tab portion at substantially right angles to the longitudinal axis of the tab portion.

23. The report cover as defined in claim 22, wherein the tab portion further includes a pair of opposing side walls each having an indentation formed therein, said indentations in the side walls lying coplanar with each other.

24. The report cover as defined in claim 23, wherein the clip is movable from a first position, where an end wall thereof contacts the apex of the spine, and a second position where the end wall of the clip lies a spaced distance from the apex of the spine.

25. The report cover as defined in claim 24, wherein the indentations on the side walls of the clip engage in the slot when the clip is in the first position; and the indentations on the side walls of the clip lie remote from the slot when the clip is in the second position.

26. The report cover as defined in claim 25, wherein a hole is formed between the end wall of the clip and the apex of the exterior portion of the spine when the clip is in the second position; and wherein the hole is adapted to receive a prong of a ring binder therein.

27. The report cover as defined in claim 26, wherein the legs of the clip lie proximate an inner surface of the exterior portion of the spine and when the clip is in the first position, the legs lie a spaced distance from the inner surface of the exterior portion of the spine, and when the clip is in the second position, the legs lie in abutting contact with the inner surface of the exterior portion of the spine.

28. The report cover as defined in claim 19, wherein the spring clips are selected from the group consisting of one of metal and plastic.

29. In combination:
a ring binder having a front and a back connected together along a spine, and having a plurality of pairs of interlocking prongs extending from the spine into a gap between the front and back; and wherein the prongs are movable between an open position and a closed position;
a plurality of report covers, each cover having an external portion of a spine with a plurality of apertures formed therein; the apertures being spaced to receive the prongs of the ring binder therethrough;
and wherein the plurality of the report covers may be individually selectively inserted into or removed from the ring binder.

30. The combination of claim 29, wherein the plurality of report covers further include a reinforcement disposed about each of the plurality of apertures formed therein.
